(19) United States
(12) Patent Application Publication
(10) Pub. No.: US 2002/0015563 A1
(43) Pub. Date: Feb. 7, 2002

(54) Optical connecting article

(76) Inventors: Takashi Murakami, Yokohama-shi (JP); Tomomi Sano, Yokohama-shi (JP); Keiji Osaka, Yokohama-shi (JP)

Correspondence Address: MCDERMOTT, WILL & EMERY, 600 13th Street, N.W., Washington, DC, 20005-3096, US

(21) Appl. No.: 09/859,803

(22) Filed: May 18, 2001

(30) Foreign Application Priority Data
May 19, 2000 (JP) P2000-148222

(51) Int. Cl. G02B 6/36; G02B 6/00

(52) U.S. Cl. 385/53; 385/137; 385/147

(57) ABSTRACT

An optical connecting article according to the present invention is comprised of a main body in which a plurality of optical fibers are distributed in an encapsulated state and in a planar shape; and a plurality of flexible branches arranged as integral with the main body and formed on the same plane as the main body, while encapsulating end portions of the respective fibers.

### BACKGROUND OF THE INVENTION

1. Field of the Invention

The present invention relates to an optical connecting article in which a plurality of optical fibers are distributed in a two-dimensional (planar) shape.

2. Related Background Art

A conventional technique in this field is one described in Japanese Patent Application Laid-Open No. H11-258447. The fiber connecting component described in this Application is one which is made by pouring a resin material into a weirlike portion and in which a number of optical fibers are encapsulated. The optical fibers extending out of the weirlike portion are led out in the form of a fiber ribbon as it is on one end side, while the fibers are led out as single fibers of the fiber ribbon on the other end side. This fiber connecting component confines portions of the single fibers in the resin material to protect the portions of the single fibers being in an easy-to-break state, thereby enhancing resistance to breakage of the fibers.

The conventional fiber connecting component described above, however, involved the following problem. For connecting optical connectors provided at the both ends of the optical fibers, to other optical connectors, there are such occasions that connection works are carried out while applying a load of bending force on the optical fibers themselves led out of the weirlike portion. If an optical connector portion is carelessly pulled or twisted on such occasions, there can be a risk of breaking an optical fiber near the optical connector, led out of the weirlike portion, or heavily affecting the optical characteristics of the optical fiber in optical communication or transmission. Thus there is the problem as to handling of the component.

The present invention has been accomplished in order to solve the above problem and a specific object of the present invention is to provide an optical connecting article that permits optical fibers to be distributed with a planar spread and in a free layout and that is improved in workability and handlability thereof.

### SUMMARY OF THE INVENTION

An optical connecting article according to the present invention comprises a main body in which a plurality of optical fibers are distributed in an encapsulated state and in a planar shape, and a plurality of flexible branches arranged as integral with the main body and formed on the same plane as the main body, while encapsulating end portions of the respective optical fibers.

In this optical connecting article, the optical fibers confined inside are distributed in a two-dimensional plane, and thus they are distributed with a planar spread. In the main body of the optical connecting article, the distribution of optical fibers can be implemented in various layouts of the optical fibers with a planar spread. In contrast to it, in the branches extending from the main body, the end portions of optical fibers are integrated every predetermined number of fibers to be arranged in parallel and the fibers can be arranged in a form similar to a fiber ribbon of multiple fibers. On the other hand, it is also feasible to separate the multi-fiber ribbon into single fibers in the middle and distribute them in the respective branches. Accordingly, use of this optical connecting article enables a variety of existing optical connectors or multi-fiber ribbons to be connected at the respective branches. Further, since the optical connecting article can be constructed so as to establish a 1:1 relation between the branches and the optical connectors or fiber ribbons, it becomes feasible to implement block connection of the opposed optical connector or fiber ribbon at every branch. Since each branch can be provided with flexibility, the optical connecting article can be constructed without taking account of an excess margin of optical fibers. In this case, each optical connector can be connected easily and surely to an opposed connector through free bending of the branch without moving or bending the main body. After the connection in this way, the optical fibers can also be brought into an almost straight state whereby the optical fibers can be prevented from suffering careless bending strain. When the optical connecting article is configured in such structure that the distal ends of the optical fibers are exposed at the ends of the branches, the tip portions of the optical fibers can be spliced to other optical components (e.g., laser diodes, photodiodes, etc.) by fusion splicing, and on the occasion of performing the splicing work, the branches can be bent branch by branch through free bending of the branches in order to position the tip portions of the optical fibers, which enhances flexibility of work and which enhances workability with a fusion splicer, without need for provision of an excess margin of the optical fibers in the branches.

In the main body, the optical fibers are preferably distributed in a mutually crossing state. This cross distribution of fibers in the main body permits the optical fibers to be distributed in various layouts, e.g., like connection between optical fibers belonging to their respective branches different from each other.

Each optical fiber is preferably encapsulated in the main body while being comprised of a combination of a straight portion with a bent portion of not less than a predetermined bend radius. This configuration permits the optical fiber to be bent in a sufficient bend radius in the bent portion in consideration of transmission loss, bending strain, and so on of the optical fiber. As a consequence, it can also avoid excess bend loss, long-term strength deterioration, and so on. Further, the straight portion ensures the shortest path. Accordingly, the combination of the bent portion with the straight portion permits the optical fibers to be distributed in various layouts. For example, it also becomes possible to substantially equate lengths of plural paths.

The main body is preferably flexible. When this configuration is adopted, the handlability of the optical connecting article is considerably improved because of the free bending of the main body and the optical connecting article formed in the planar shape can be used in a bent state in a predetermined bend radius.

The main body is preferably provided with slits to form the branches. When this configuration is employed, the branches can be made by a simple work of integrally molding both the main body and branches and thereafter slitting the main body.

It is also preferable to connect a multi-fiber or single-fiber connector at a distal end of each branch. This configuration is utilized for connection through the optical connector between the optical connecting article and a partner connector.

Each optical fiber is preferably encapsulated as sandwiched between a flexible substrate and a flexible coating member. When this configuration is employed, it enables a sandwiching work of the optical fibers with the plurality of flexible members, allows the optical fibers to be distributed readily in the main body, and also effectively prevents the optical fibers from being damaged.

It is also preferable that an adhesive layer for securing each optical fiber be provided on a surface of the substrate. When this configuration is employed, the optical connecting article can be formed by encapsulating the optical fibers by a simple work of distributing the optical fibers in a predetermined layout on the adhesive layer laid on the substrate and then mounting the flexible coating member on the substrate.

It is also preferable that a plurality of main bodies be stacked one over another. When this configuration is employed, the optical fibers can be distributed readily in multilayered structure to realize a complicated distribution pattern hardly achieved by single layer structure.

It is also preferable to place a reinforcement plate so as to deploy between the main body and the branches. When this configuration is adopted, the reinforcement plate can suppress the shaking of the branches and it also becomes feasible to secure the optical connecting article by fixing with the reinforcement plate, for installing the article at a predetermined position in a device or an equipment.

The reinforcement plate is preferably placed on at least either of the main body and the branches. When this configuration is adopted, the optical connecting article can be carried readily and prevented from being broken because of handling, during storage or movement before mounting of the article. When the reinforcement plate is placed individually on each branch, it properly reinforces the shape of the branch, so as to prevent forced bending of the branch, and it can maintain the appropriate shape even under external stress, so as to stabilize the optical characteristics.

The reinforcement plate is preferably provided with a through hole for fixing. When this configuration is adopted, the optical connecting article can be readily fixed to a device, a predetermined substrate, or the like by use of the through hole on the occasion of mounting the article on the device or the like. After mounted, the optical connecting article is kept from moving, thereby stabilizes the optical characteristics. When the through hole is provided in the reinforcement plate of the branch, the branch can be readily and properly fixed to a device or the like, so as to cause no forced bending thereof, and during a work of coupling or decoupling an optical connector at an end of an adjacent branch or during a work of splicing fibers there, the branch thus fixed can be prevented from being affected thereby, which stabilizes the optical characteristics.

The present invention can be fully understood from the detailed description and the accompanying drawings which will follow, but it is to be understood that the present invention is by no means limited thereto. Further, the scope of application of the present invention will become apparent from the detailed description which will follow. However, modifications and improvements within the scope of the present invention must be obvious to those skilled in the art in view of the detailed description, and it is thus to be understood that the detailed description and specific examples in the description of preferred embodiments of the present invention are provided simply for illustration.

### BRIEF DESCRIPTION OF THE DRAWINGS

FIG. 1 is a plan view showing the first embodiment of the optical connecting article according to the present invention.

FIG. 2 is a side view of the optical connecting article shown in FIG. 1.

FIG. 3 is an enlarged view of main part of the optical connecting article shown in FIG. 1.

FIG. 4 is a plan view of enlarged main part showing the second embodiment of the optical connecting article according to the present invention.

FIG. 5 is a cross-sectional view along line V-V of FIG. 1.

FIG. 6 is a plan view showing a reinforcement plate applied to the optical connecting article according to the present invention.

FIG. 7 is a cross-sectional view along line VII-VII of FIG. 6.

FIG. 8 is a cross-sectional view along line VIII-VIII of FIG. 6.

FIG. 9 is a plan view showing another reinforcement plate applied to the optical connecting article according to the present invention.

FIG. 10 is a cross-sectional view along line X-X of FIG. 9.

FIG. 11 is a cross-sectional view along line XI-XI of FIG. 9.

FIG. 12 is a plan view showing the third embodiment of the optical connecting article according to the present invention.

FIG. 13 is a perspective view of enlarged main part of FIG. 12.

FIG. 14 is a plan view showing the fourth embodiment of the optical connecting article according to the present invention.

FIG. 15 is a perspective view of enlarged main part of FIG. 14.

FIG. 16 is a plan view showing the fifth embodiment of the optical connecting article according to the present invention.

FIG. 17 is a plan view showing the sixth embodiment of the optical connecting article according to the present invention.

FIG. 18 is a plan view showing the seventh embodiment of the optical connecting article according to the present invention.

FIG. 19 is a plan view showing another embodiment of the reinforcement plate.

FIG. 20 is a plan view showing still another embodiment of the reinforcement plate.

FIG. 21 is a plan view showing still another embodiment of the reinforcement plate.

FIG. 22 is a plan view showing still another embodiment of the reinforcement plate.

FIG. 23 is a plan view showing still another embodiment of the reinforcement plate.

### DESCRIPTION OF THE PREFERRED EMBODIMENTS

A variety of preferred embodiments of the optical connecting article according to the present invention will be described below in detail with reference to the drawings.

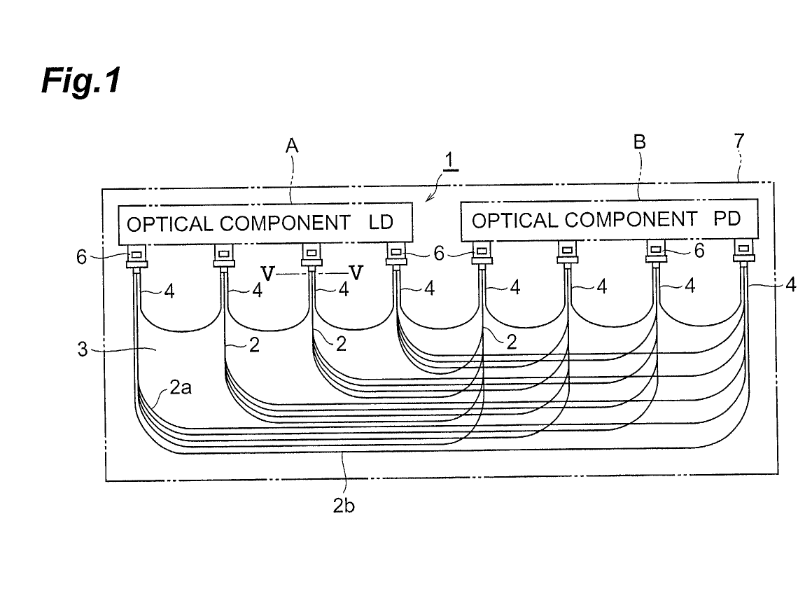

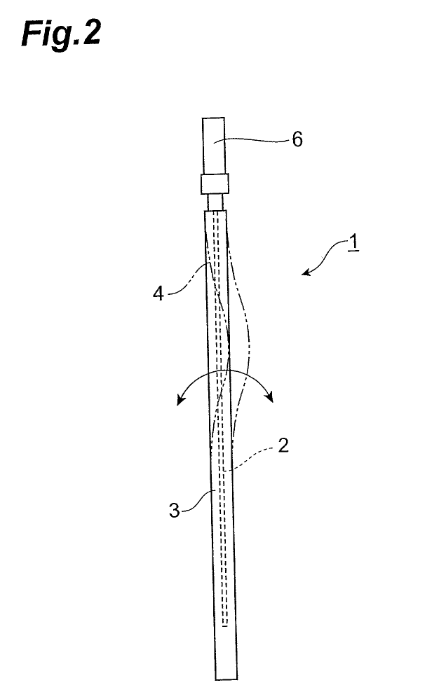

As shown in FIG. 1 and FIG. 2, the optical connecting article 1 is a sheetlike component encapsulating a plurality of optical fibers 2 in a flexible material with elastic restitution (e.g., plastic materials such as acrylic resin, urethane, epoxy resin, polyimide, polyethylene, silicone resin, UV acrylic resin, UV urethane resin, and so on) and is formed in a planar shape. This optical connecting article 1 has a horizontally long, main body 3 extending in a planar form, and the predetermined number of (eight in this case) branches 4 project from the main body 3 so as to be horizontally arrayed in the longitudinal direction of the main body 3. The main body 3 and the branches 4 are integrally made of a material of the same kind and are arranged in the same plane. If the main body 3 and branches 4 are made of a transparent material, the layout of the internal distribution of fibers can be visually recognized from the outside, which considerably improves the handlability thereof.

Further, end portions of optical fibers 2 are encapsulated in each branch 4 and the rest portions of the optical fibers are encapsulated in the main body 3. The optical fibers 2 are distributed with a planar spread. A specific layout of fiber distribution is such that four fibers 2 extending from one branch 4 are distributed each into four other branches 4. Then each branch 4 is provided with a multi-fiber connector 6 including four fibers to enable connection with another optical connector.

Further, each optical fiber 2 consists of a combination of a straight portion 2b with bent portions 2a as encapsulated in the main body 3. Accordingly, the bent portions 2a ensure a sufficient bend radius determined in consideration of transmission loss and bending strain of the optical fiber 2 and the straight portion 2b ensures the shortest path. Further, in the main body 3 the optical fibers 2 are distributed in a mutually crossing state. Namely, the cross distribution of fibers in the main body 3 enables the optical fibers to be distributed in various layouts, e.g., like connection between branches 4. When such fiber distribution configurations are employed, the optical connecting article 1 is constructed in various shapes with a planar spread in accordance therewith.

As described above, the optical fibers are distributed in various layouts with a planar spread in the main body 3 of the optical connecting article 1 and the end portions of optical fibers 2 are integrated every predetermined number of fibers (every four fibers in this case) in the branches 4 extending from the main body 3. This permits an optical connector 6 to be provided at every branch 4 whereby the optical connecting article 1 is realized so as to establish the 1:1 relation between the branches 4 and optical connectors 6.

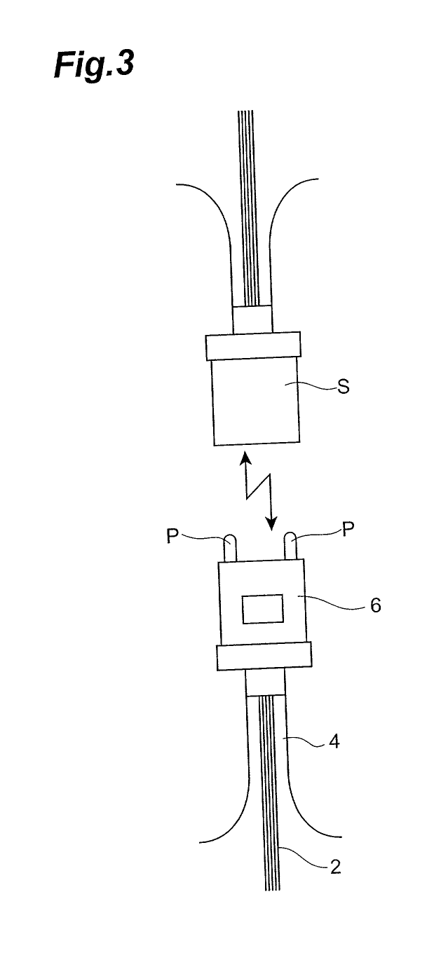

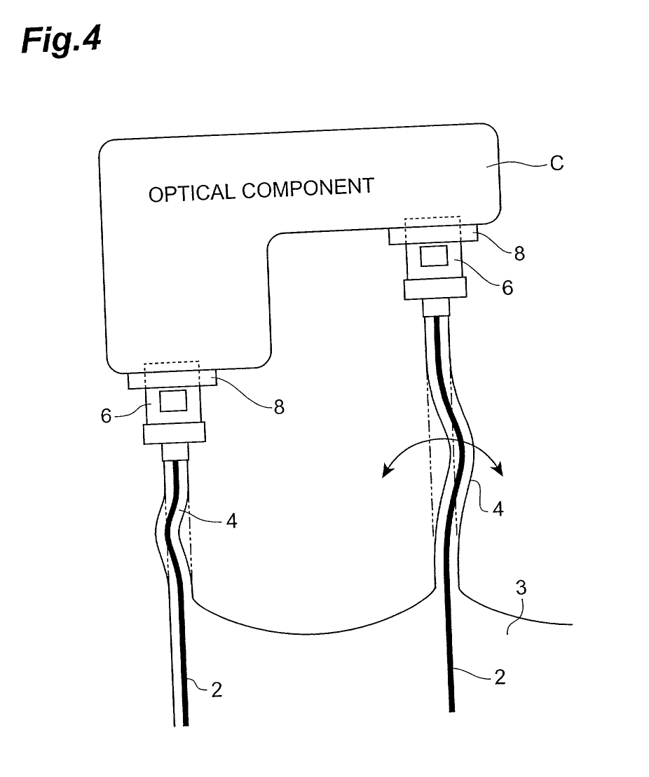

Further, in a configuration wherein the optical fibers 2 are set in optimal distribution without local bending of fibers, even if the main body 3 is secured at a certain place, there is no need for provision of an excess margin (extra length) for the optical fibers 2, because each branch 4 is flexible. Even in the fixed state of the main body 3, free bending of the branches 4 permits each connector 6 to be readily and surely connected through guide pins P to another connector S (see FIG. 3). Since the branches 4 are individually arranged and bent independently of each other, connection characteristics of a certain branch 4 do not affect those of the other branches 4. In FIG. 1, the optical connecting article 1 is mounted and fixed on a hard plate 7 whereby each of the four left connectors 6 can be coupled and fixed to an optical component (e.g., a laser diode) A while each of the four right connectors 6 can be coupled and fixed to another optical component (e.g., a photodiode) B. Another conceivable configuration is such that lengths of the respective branches 4 are made different from each other according to positions of connecting portions 8 of an optical component C, as shown in FIG. 4. As described above, it is feasible to preliminarily design and manufacture the optical connecting article so as to leave almost no slack after the connection.

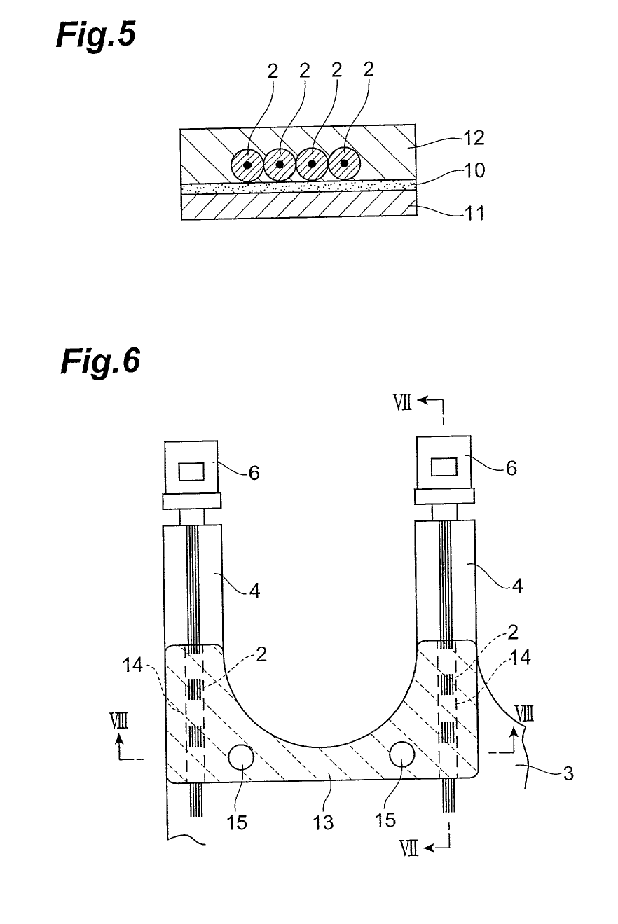

Production steps of the optical connecting article 1 will be described below. First prepared is a flexible substrate 11 (see FIG. 5) of polyimide with an adhesive (adhesive layer) 10 across the entire surface on one side. Alternatively, an adhesive sheet may be laid on the substrate 11. Then the optical fibers 2 are laid on the substrate 11 with the adhesive surface up, so that the desired fiber distribution as shown in FIG. 1 can be achieved readily. Since the optical fibers are distributed on the adhesive 10 in this way, the layout is not disturbed during the fiber distribution work, thus facilitating the work.

After completion of this distribution work of optical fibers 2, a coating member 12 of silicone resin is pressed onto the optical fibers 2. As a result, the optical fibers 2 are interposed between the substrate 11 and the coating member 12, so that the optical fibers 2 are encapsulated in the optical connecting article 1. After that, a predetermined cutting work with a knife is carried out to form the branches 4 and the main body 3, thereby making the optical connecting article 1 as shown in FIG. 1. Then the optical connectors 6 are fixed to the distal ends of the optical fibers 2 projecting from the tips of the branches 4, thus completing a series of works. A similar result can be achieved by applying the coating member 12 of the same resin material, thereafter gluing a separator sheet thereonto, curing the resin, and stripping the resin off. In this case, the resin surface becomes extremely smooth after the curing and thus the connection work can be performed with little contact resistance, thus enhancing the workability of connection. The stripping of the separator sheet can also be done after the cutting work. The cutting work can also be implemented by another method of punching or the like with a press mold, instead of the knife.

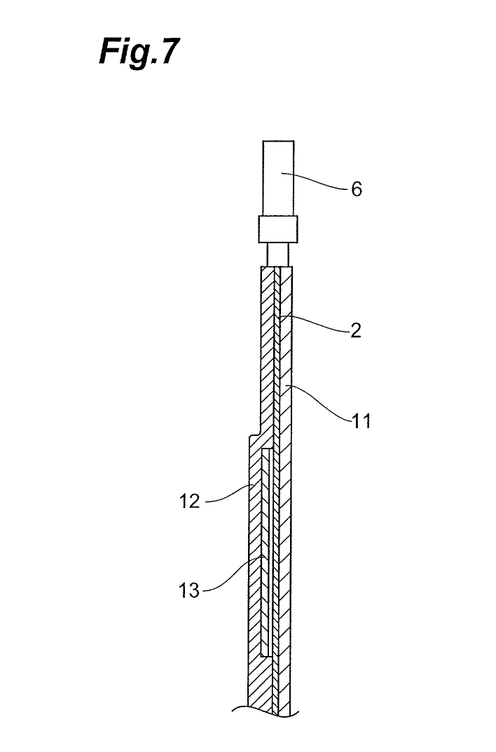

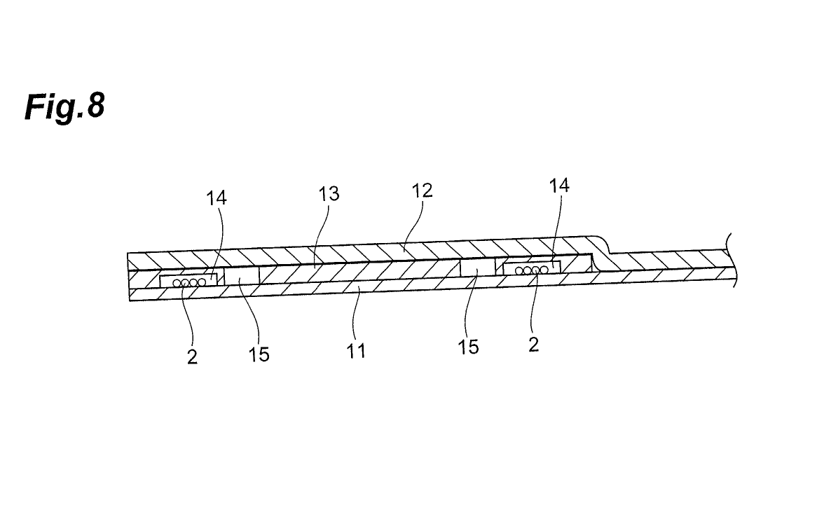

Here a plastic or metal reinforcement plate 13 may be placed between the substrate 11 and the coating member 12, as shown in FIG. 6 to FIG. 8. This reinforcement plate 13 is placed so as to deploy between the main body 3 and the branches 4. Particularly, the reinforcement plate is placed so as to bridge between adjacent branches 4. As a result, the reinforcement plate 13 can flatten a twist, a curve, a bulge, or the like of the branches 4 and the main body 3 so as not to affect the connection portions at the ends, and through the reinforcement plate 13 the optical connecting article 1 being flexible and hard to fix can be properly fixed to a predetermined device or to the aforementioned hard plate 7. Of course, the reinforcement plate 13 may be placed independently only for the main body 3 or only for the branches 4 in an optimized shape according to a purpose.

Specifically, trenches 14 for avoiding interference with the optical fibers 2 are formed at both side portions of the reinforcement plate 13 and through holes 15 are bored at positions off the optical fibers 2 between the left and right trenches 14. Accordingly, the optical connecting article 1 can be firmly fixed to a predetermined device or to the predetermined plate 7 by screwing screws or the like into the through holes 15 so as to penetrate the optical connecting article 1. It is also feasible to couple or decouple the optical connectors at the ends of the branches as the optical connecting article 1 is thus secured.

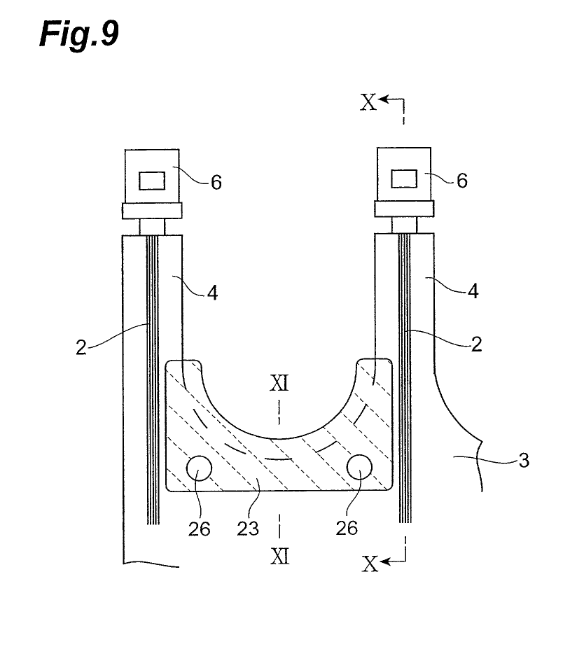

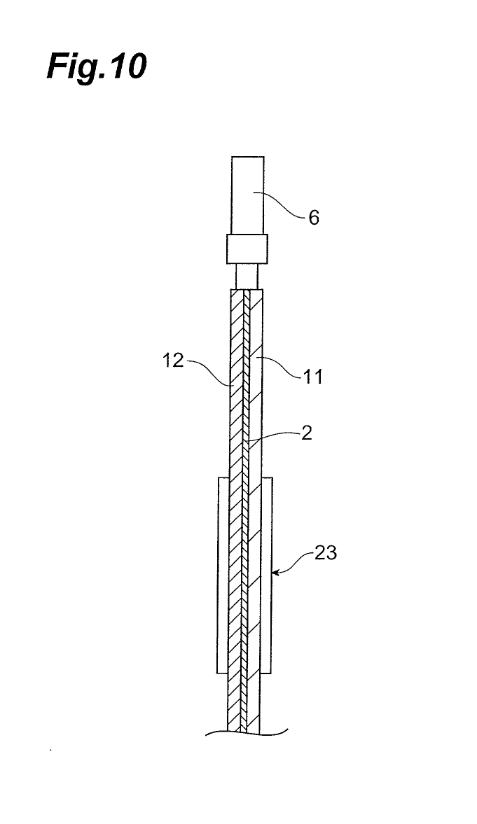

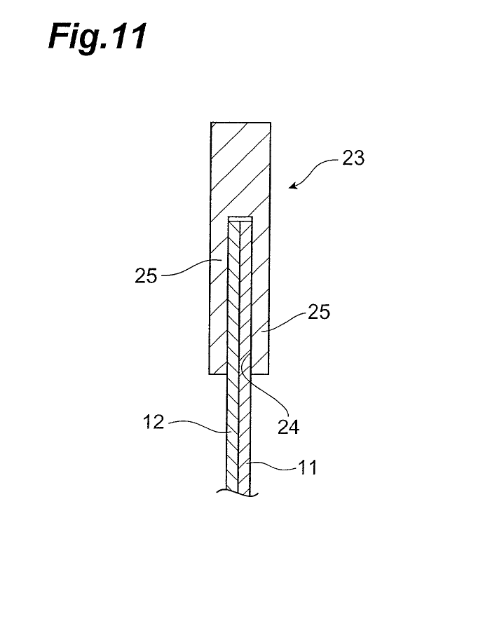

As shown in FIGS. 9 to 11, another reinforcement plate 23 is arranged to extend between the main body 3 and the branches 4 and deploy between adjacent branches 4 and to nip the substrate 11 and the coating member 12 from the outside. Since this reinforcement plate 23 is not preliminarily built in the article, different from the foregoing reinforcement plate 13, it can be mounted onto the optical connecting article 1 at any convenient time. For this reason, the optical connecting article can be secured at an optimal position regardless of its shape, which increases degrees of freedom for design of connection and for the connecting work.

Specifically, the reinforcement plate 23 is provided with an insertion slot 24 extending laterally, and the substrate 11 and the coating member 12 are sandwiched and fixed by a pair of nipping flanges 25 making the insertion slot 24. Further, this reinforcement plate 23 is provided with through holes 26. Accordingly, the optical connecting article 1 can be firmly fixed to a predetermined device or to the predetermined plate 7 by screwing screws or the like into the through holes 26 so as to penetrate the optical connecting article 1.

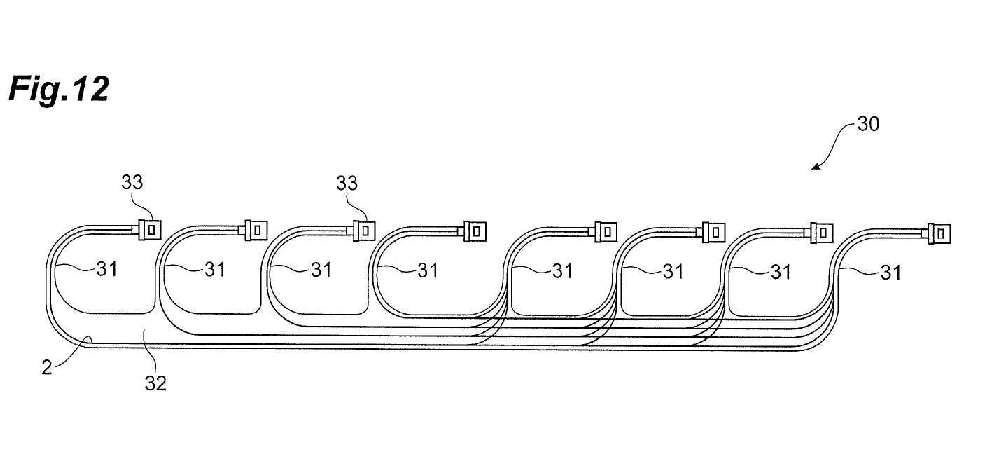

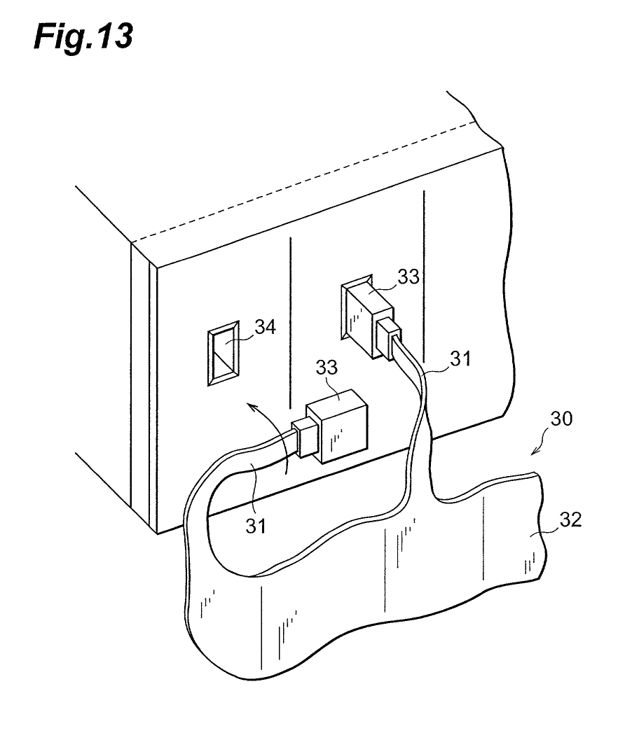

The optical connecting articles according to the present invention are not limited to the foregoing embodiments. For example, another optical connecting article 30 with a planar spread as shown in FIGS. 12 and 13 has branches 31 formed in a nearly L-shape, and the branches 31 extend in the same shape from the main body 32. An optical connector 33 is fixed to a distal end of each branch 31 and the optical connectors 33 are aligned on a straight line in the longitudinal direction of the main body 31. Then each branch 31 is bent to couple the optical connector 33 at the distal end to an inlet port 34 on the device side. The branches 31 of this type can be said as those with high general versatility, because each optical connector 33 can be surely fitted into each inlet port 34 on the device side even with slight deviation between the array pitch of the branches 31 and the array pitch of the device-side inlet ports 34, thanks to the free flexibility of the branches.

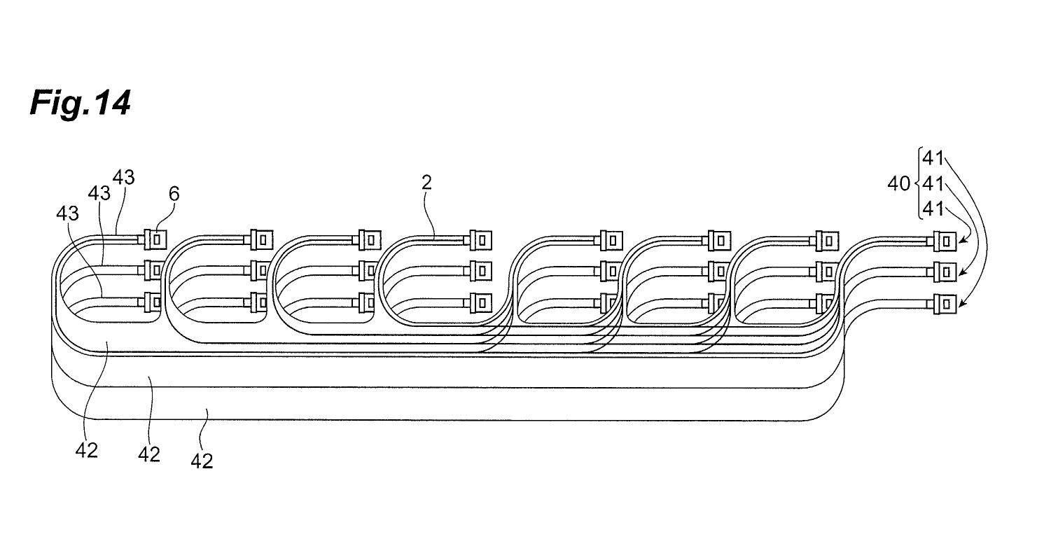

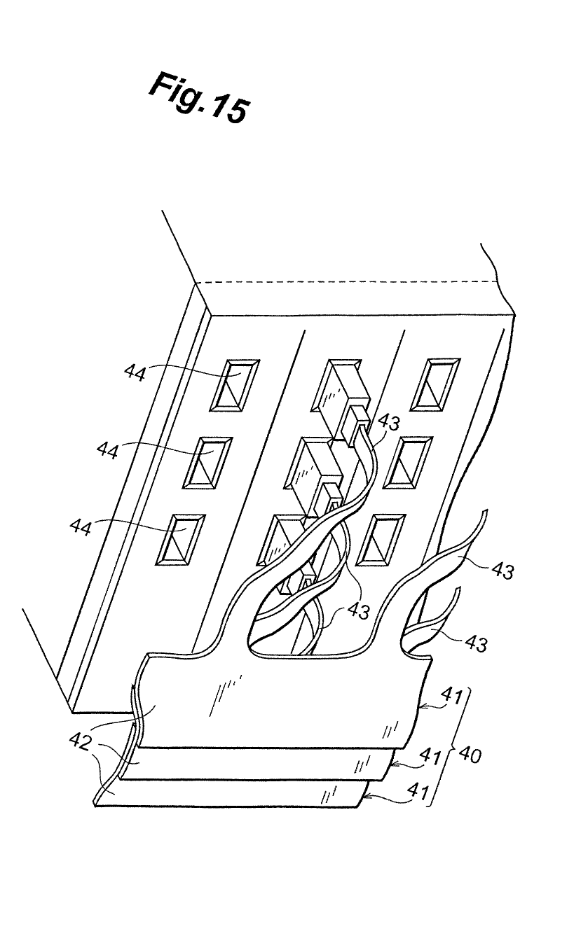

Another optical connecting article 40 as shown in FIGS. 14 and 15 consists of optical connecting articles 41 of the same shape stacked one over another through an adhesive. For example, the main bodies 42 may be arranged in a stepwise structure with offsets in vertical and widthwise directions. In this case, the main bodies 42 are bonded and fixed to each other and, at the same time as it, the branches 43 are arranged with stepwise offsets in the widthwise direction. The optical connecting article 40 of this structure is effective, particularly, to configurations in which device-side inlets 44 are arrayed in a vertical and lateral matrix. The number of the stacked articles is preferably equal to the number of rows of the inlets 44 in the vertical direction.

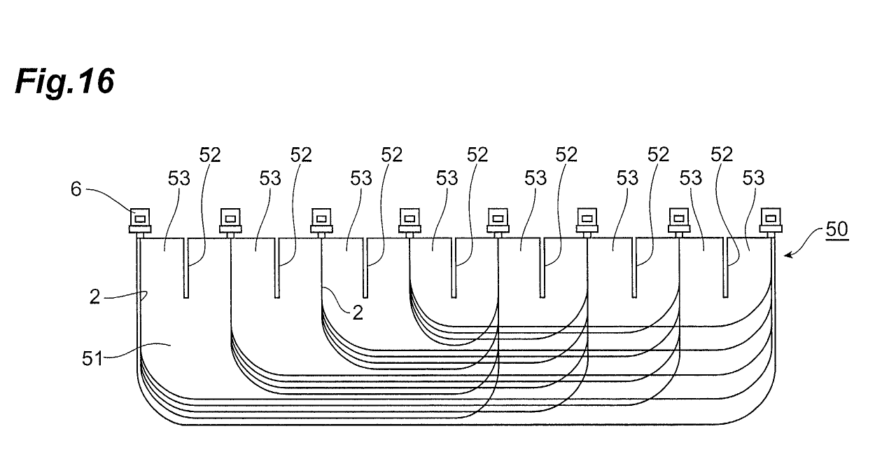

In another optical connecting article 50 as shown in FIG. 16, the main body 51 is provided with linear slits 52 to form the branches 53. Specifically, after the optical fibers are distributed in the main body 51, the slits are cut at constant intervals, thereby readily making the branches 53. It is needless to mention that the cutting work is done so as to arrange end portions of four fibers 2 in each branch 53.

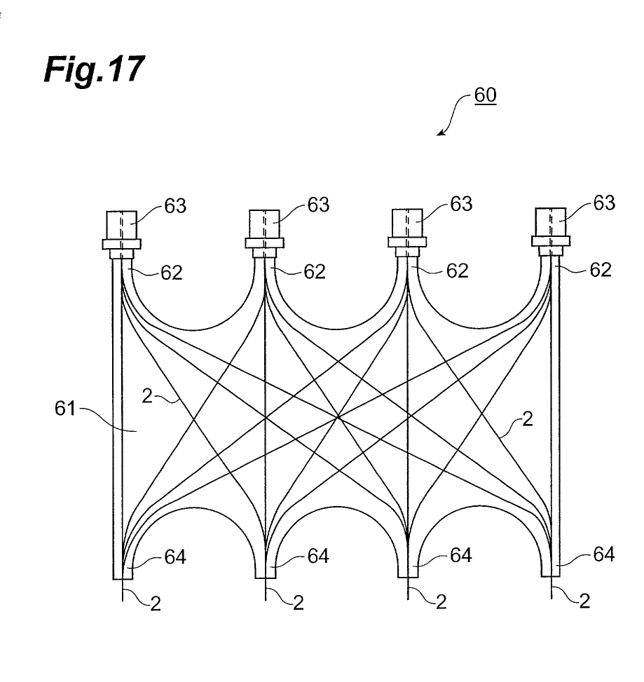

In another optical connecting article 60 as shown in FIG. 17, a plurality of branches 62 are juxtaposed at the two opposed ends of the main body 61 and optical fibers 2 are radially distributed so that a certain branch 62 is connected through four optical fibers 2 to the four branches 64 on the opposite side. This realizes such distribution that the optical fibers cross each other at their straight portions. An optical connector 63 is fixed to each branch 62 in one row, while the distal portions of the optical fibers 2 are exposed from each branch 64 in the other row. These exposed portions are portions utilized in the fusion splicing work with another optical article.

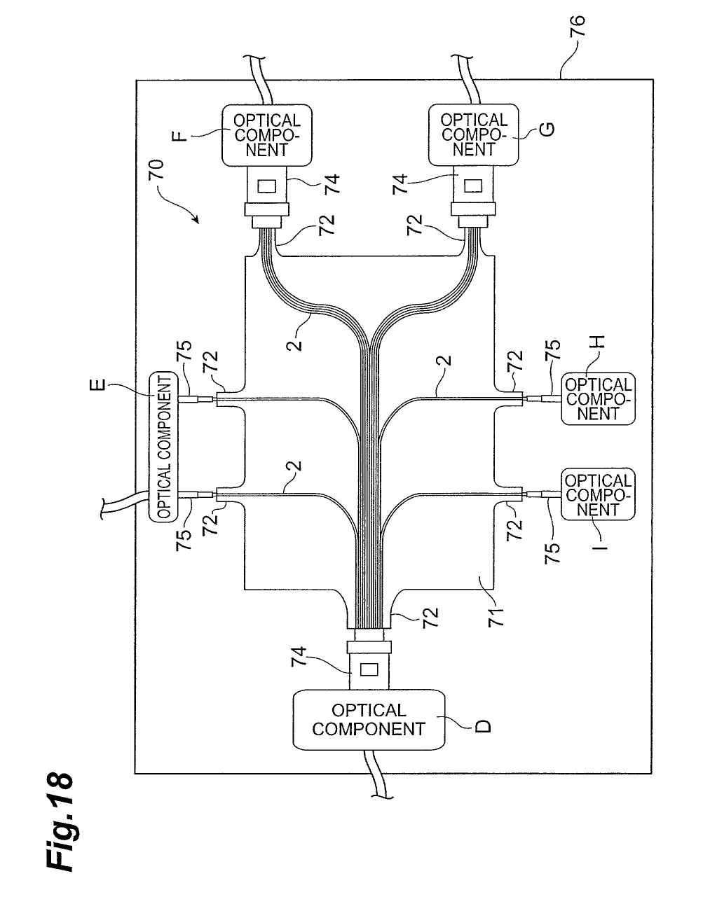

Another optical connecting article 70 as shown in FIG. 18 is an example in which the optical fibers 2 are distributed in a non-crossing layout, in which branches 72 are located on each side of the rectangular main body 71, and in which a multi-fiber connector 74 or single-fiber connector 75 is provided at each branch 72. Then optical components D to I are connected to the respective connectors 74, 75. In this example, the optical component D is a multiplexer, the optical component E a 1×2 switch, the optical components F, G optical switches, and the optical components H, I laser diodes. In this way the various optical components are arranged around the main body 71 and secured on an electric circuit board 76 incorporating driving circuits for the optical components.

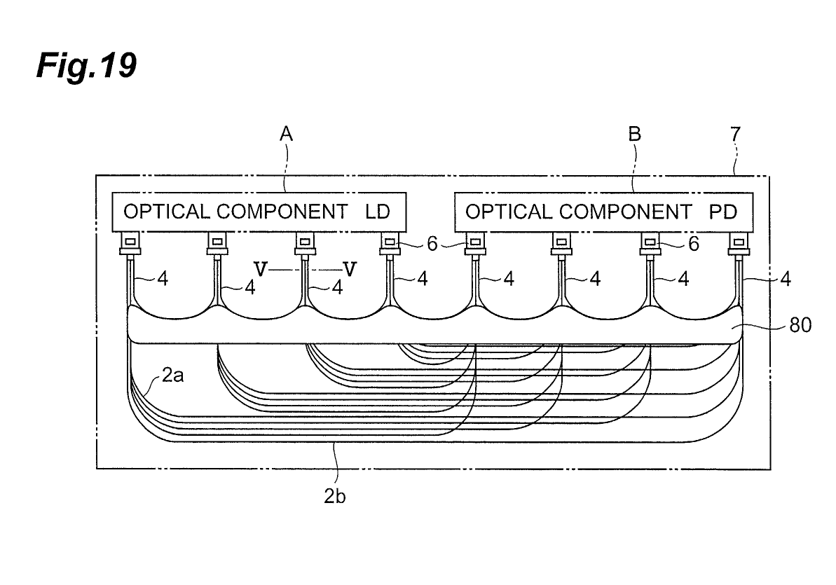

A reinforcement plate 80 may be placed only for the main body 3, as shown in FIG. 19. In this case the reinforcement plate 80 may be either buried in or externally attached to the main body 3. In the case of this configuration being employed, during storage or movement before mounting of the optical connecting article, it is feasible to carry the article easily and handle it without breakage. It is also needless to mention that the reinforcement plate 80 can be provided with through holes for fixing. The same components as those in the optical connecting article of FIG. 1 are denoted by the same reference symbols and the description thereof is omitted herein.

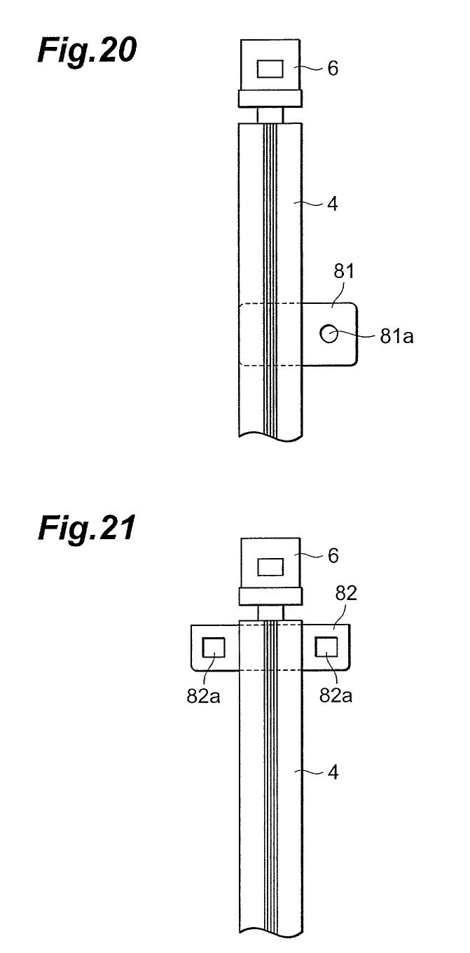

As shown in FIG. 20, a reinforcement plate 81 may be placed for a branch 4 and in this case the reinforcement plate 81 may be either buried in or externally attached to the branch 4. In this configuration wherein the reinforcement plate 81 is placed for each individual branch 4, the reinforcement plate properly reinforces the shape of the branch 4, so as to cause no forced bending of the branch 4, and it can also maintain the appropriate shape even under external stress, so as to stabilize the optical characteristics. It is then preferable to provide the reinforcement plate 81 with a through hole 81a. In the case of this configuration being employed, each branch 4 can be easily and properly fixed to a device, a substrate, or the like, is free of forced bending, and, even during a work of coupling or decoupling the optical connector 6 at a distal end of an adjacent branch 4 or during a work of splicing fibers there, the branch thus fixed is not affected by the work, so as to stabilize the optical characteristics.

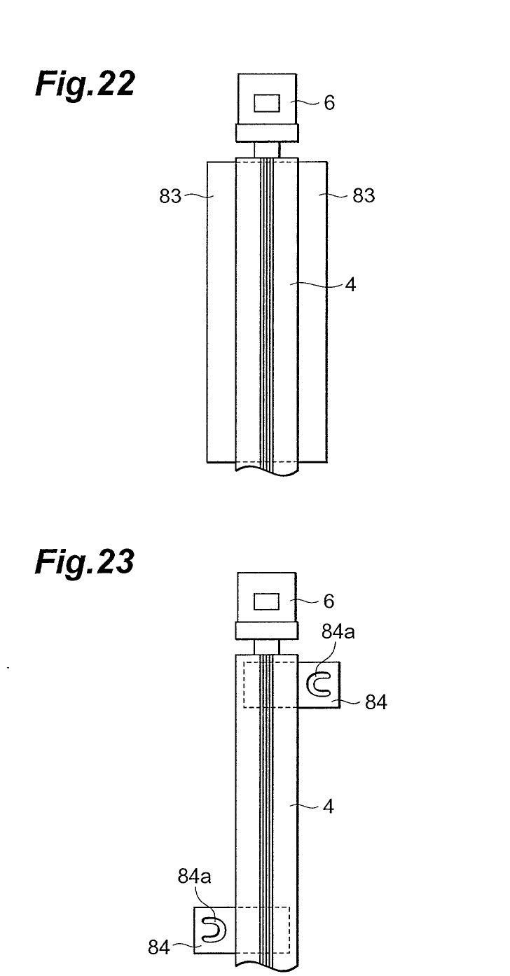

Similarly, another reinforcement plate 82 projecting from the both side portions of the branch 4 may be placed for the branch 4, as shown in FIG. 21, and the reinforcement plate 82 may also be provided with through holes 82a on the both sides of the branch 4. In order to ensure the prevention of bending of the branch 4, another reinforcement plate 83 may be placed over the almost entire length of the branch 4, as shown in FIG. 22. As shown in FIG. 23, reinforcement plates 84 may be arranged in an offset state in the longitudinal direction of the branch 4 and a C-shaped through hole 84a for hooking may be formed in each reinforcement plate 84.

Although not shown, the optical connecting article may be configured in such structure that the distal ends of the optical fibers are projected from all the branches without the optical connectors at the ends. This optical connecting article permits post-mounting of the optical connectors and fusion splicing to another optical component, thus taking general versatility into consideration. Instead of the configuration of the optical fibers 2 interposed between the flexible substrate and the flexible coating member, the optical connecting article may also be molded by a manufacturing method of confining the optical fibers 2 in a flexible material. The foregoing optical fibers 2 may be of either single-fiber structure or multiple-fiber structure.

It is obvious from the foregoing invention that the embodiments of the present invention can be modified in many methods. It is to be understood that such modifications do not depart from the spirit and scope of the present invention and all such improvements obvious to those skilled in the art are embraced in the scope of the claims which follow.

What is claimed is:

1. An optical connecting article comprising:
a main body in which a plurality of optical fibers are distributed in an encapsulated state and in a planar shape; and
a plurality of flexible branches arranged as integral with said main body and formed on the same plane as said main body, while encapsulating end portions of said respective fibers.

2. The optical connecting article according to claim 1, wherein said optical fibers are distributed in a mutually crossing state in said main body.

3. The optical connecting article according to claim 1, wherein each of said optical fibers is encapsulated in said main body while being comprised of a combination of a straight portion with a bent portion of not less than a predetermined bend radius.

4. The optical connecting article according to claim 1, wherein said main body is flexible.

5. The optical connecting article according to claim 1, wherein said main body is provided with slits to form said branches.

6. The optical connecting article according to claim 1, wherein a multi-fiber or single-fiber connector is connected to a distal end of said branch.

7. The optical connecting article according to claim 1, wherein said optical fibers are encapsulated as sandwiched between a flexible substrate and a flexible coating member.

8. The optical connecting article according to claim 7, wherein an adhesive layer for securing said optical fibers is provided on a surface of said substrate.

9. The optical connecting article according to claim 1, wherein a plurality of main bodies are stacked one over another.

10. The optical connecting article according to claim 1, wherein a reinforcement plate is placed so as to deploy between said main body and said branches.

11. The optical connecting article according to claim 10, wherein said reinforcement plate is provided with a through hole for fixing.

12. The optical connecting article according to claim 1, wherein a reinforcement plate is placed on at least either of said main body and said branches.

13. The optical connecting article according to claim 12, wherein said reinforcement plate is provided with a through hole for fixing.
